(19) United States
(12) Patent Application Publication
(10) Pub. No.: US 2026/0203525 A1
(43) Pub. Date: Jul. 16, 2026

(54) INFORMATION PROCESSING DEVICE, LABELING METHOD, AND NON-TRANSITORY COMPUTER READABLE MEDIUM

(71) Applicant: NEC Corporation, Tokyo (JP)

(72) Inventors: Masaharu MORIMOTO, Tokyo (JP); Yoshiaki Sakae, Tokyo (JP); Joe Brinton, Tokyo (JP); Siane Ooi, Tokyo (JP); Masaki Inokuchi, Tokyo (JP); Ryosuke Hotchi, Tokyo (JP); Shunsuke Osaki, Tokyo (JP); Tatsuya Fukuda, Tokyo (JP)

(73) Assignee: NEC Corporation, Tokyo (JP)

(21) Appl. No.: 19/430,581

(22) Filed: Dec. 23, 2025

(30) Foreign Application Priority Data
Jan. 15, 2025 (JP) 2025-005708

(51) Int. Cl. G06F 40/40

(52) U.S. Cl. CPC G06F 40/40

(57) ABSTRACT

An object of the present disclosure is to enable a series of works for creating a product to be analyzed in accordance with an actual state of the work. An information processing device includes a creation location specifying unit for specifying a location created by a partial work that is a part of a series of works in a product created by the series of works, and a labeling unit for determining a label to be given to the partial work by using a language model, caused to machine learn a natural language, based on the location specified by the creation location specifying unit. According to this information processing device, it is possible to visualize the contents of a series of works, identify the work that is a bottleneck, and eventually optimize the entire series of work.

### INCORPORATION BY REFERENCE

This application is based upon and claims the benefit of priority from Japanese patent application No. 2025-005708, filed on Jan. 15, 2025, the disclosure of which is incorporated herein in its entirety by reference.

### TECHNICAL FIELD

The present disclosure relates to an information processing device, a labeling method, and a labeling program.

### BACKGROUND ART

Techniques for supporting efficiency of various types of operations are known. An example of a technique for supporting operational efficiency includes, for example, an operational efficiency support system described in Japanese Laid-Open Patent Publication No. 2021-157357.

The operational efficiency support system creates a current operation flow by classifying operation data indicating a content of the operation, a person in charge, a product, and the like into a plurality of work steps. Then, the operational efficiency support system compares the current operation flow for each of a plurality of different operations, and creates a standard operation flow including a standard operation step that is an ideal work step.

### SUMMARY

As in the operational efficiency support system described in Japanese Laid-Open Patent Publication No. 2021-157357, it is effective to subdivide and analyze a series of works in the operation as a measure for improving the operational efficiency. However, it is not easy to subdivide and analyze the work in consideration of even specific work contents. For example, in the operational efficiency system, work steps are classified based on attribute information input by a user. Therefore, in a case where the input attribute information is not valid, it is considered that there is a high possibility that a standard operation flow not conforming to the actual state of the work is created, and the effect of improving the efficiency is limited.

The present disclosure has been made in view of the above problems, and an example object thereof is to provide a technique that enables a series of works for creating a product to be analyzed in accordance with the actual state of the work.

An information processing device according to one example aspect of the present disclosure includes a creation location specifying means for specifying a location created by a partial work that is a part of a series of works in a product created by the series of works, and a labeling means for determining a label to be given to the partial work by using a language model, caused to machine learn a natural language, based on the location specified by the creation location specifying means.

In a labeling method according to one example aspect of the present disclosure, in which at least one processor executes creation location specifying processing of specifying a location created by a partial work that is a part of a series of works in a product created by the series of works, and labeling processing of determining a label to be given to the partial work by using a language model, caused to machine learn a natural language, based on the location specified in the creation location specifying processing.

A labeling program according to one example aspect of the present disclosure causes a computer to function as a creation location specifying means for specifying a location created by a partial work that is a part of a series of works in a product created by the series of works, and a labeling means for determining a label to be given to the partial work by using a language model, caused to machine learn a natural language, based on the location specified by the creation location specifying means.

According to one example aspect of the present disclosure, an exemplary effect that a technique that enables a series of works for creating a product to be analyzed in accordance with an actual state of the work can be provided is obtained.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of an information processing device according to the present disclosure;

FIG. 2 is a flowchart illustrating a flow of a labeling method according to the present disclosure;

FIG. 3 is a block diagram illustrating a configuration of another information processing device according to the present disclosure;

FIG. 4 is a diagram illustrating an outline of processing executed by the information processing device illustrated in FIG. 3;

FIG. 5 is a diagram illustrating an example of labeling;

FIG. 6 is a diagram illustrating an example of a display screen displayed by a presentation control unit;

FIG. 7 is a flowchart illustrating a flow of processing executed by the information processing device illustrated in FIG. 3; and

FIG. 8 is a block diagram illustrating a configuration of a computer that functions as an information processing device according to the present disclosure.

### EXAMPLE EMBODIMENTS

Hereinafter, example embodiments of the present disclosure will be exemplified. However, the present disclosure is not limited to the following exemplary example embodiments, and various modifications can be made within a scope described in the claims. For example, example embodiments obtained by appropriately combining techniques (some or all of things or methods) adopted in the following exemplary example embodiments can also be included in the scope of the present disclosure. Example embodiments obtained by appropriately omitting some of the techniques adopted in the following exemplary example embodiments can also be included in the scope of the present disclosure. Effects mentioned in the following exemplary example embodiments are examples of effects expected in the exemplary example embodiments, and do not define extension of the present disclosure. That is, example embodiments that do not provide the effects mentioned in each of the exemplary example embodiments described below can also be included in the scope of the present disclosure.

### First Exemplary Example Embodiment

A first exemplary example embodiment that is an example of the example embodiments of the present disclosure will be described in detail with reference to the drawings. The present exemplary example embodiment is a basic form of each exemplary example embodiment to be described below. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Furthermore, each technique illustrated in the drawings referred to for describing the present exemplary example embodiment can also be adopted in another exemplary example embodiment included in the present disclosure within a range in which no particular technical problem occurs.

### (Configuration of Information Processing Device 1)

A configuration of an information processing device 1 according to the present exemplary example embodiment will be described with reference to FIG. 1. FIG. 1 is a block diagram illustrating a configuration of the information processing device 1. As illustrated in FIG. 1, the information processing device 1 includes a creation location specifying unit 101 and a labeling unit 102.

The creation location specifying unit 101 specifies a portion created by a partial work that is a portion of the series of works in the product created by the series of work. The subject performing the series of works may be all persons, or a part or all of the series of works may be performed by a subject other than a person such as artificial intelligence. Furthermore, the series of works may be performed using one or a plurality of electronic devices (e.g., a computer), or a part or all of the series of works may be performed without using the electronic device.

The product is an electronic product, in other words, electronic data. For example, the product may be document data such as a report, a design document, or a plan document created using a computer. The content of the product is not particularly limited. For example, the product may be a design document of software or software-related data such as a computer program. Furthermore, for example, the product may be a medical document such as a medical certificate. As described above, the information processing device 1 can also be applied to the field of healthcare. The product may be a non-electronic product (e.g., a physical product, etc.).

In addition, the creation location specifying unit 101 may specify a part of the product as a “location created by partial work” (hereinafter, referred to as a creation location), or may specify a converted object obtained by converting a part of the product or the like as the creation location. Furthermore, in a case where the product is to be completed by conversion, the creation location specifying unit 101 may specify a part of the product before conversion as the creation location. For example, it is assumed that the product is a computer program. In this case, the creation location specifying unit 101 may specify a part of the source code before compilation as the creation location, or may specify a part of the object code obtained by compiling the source code as the creation location. Similarly, for example, in a case where text data that can be converted into an image is a product, the creation location specifying unit 101 may specify a part of the text data as the creation location, or may specify a part of the image as the creation location. The creation location specifying unit 101 may directly or indirectly specify the creation location in the product.

The labeling unit 102 determines a label to be given to the partial work by using a language model, caused to machine learn a natural language, based on the creation location specified by the creation location specifying unit 101. Hereinafter, the language model used by the labeling unit 102 is referred to as a language model M. It can be said that the labeling unit 102 gives names to partial works and classifies partial works. Therefore, in the following description, label determination, labeling, labeling, and the like can also be referred to as a name, a classification, or the like.

Here, machine learning on natural language more specifically means learning of the arrangement of constituent elements (words etc.) in a sentence of a natural language and the arrangement of a sentence and a sentence in a writing. Examples of the language model obtained by learning the natural language include Bidirectional Encoder Representations from Transformers (BERT), Robustly optimized BERT approach (RoBERTa), Efficiently Learning an Encoder that Classifies Token Replacements Accurately (ELECTRA), and the like.

Furthermore, determining the label based on the creation location means directly or indirectly using the creation location in determining the label. How to use the creation location in determining the label is not particularly limited. For example, if the creation location is a text described in a natural language, the labeling unit 102 may input the creation location as it is to the language model M. Furthermore, in a case where the creation location is data in a format other than text, the labeling unit 102 may convert the data into a text format and input it to the language model M. In addition, some language models are configured and learned in such a way that data in a format other than text such as an image can be input. In a case where such a language model (a language model to which data in a format other than text can be input) is used as the language model M, the labeling unit 102 can input a creation location in a format other than text as it is to the language model M. Furthermore, for example, the labeling unit 102 can perform labeling using an image obtained by photographing the creation location, an explanatory sentence of an object appearing in the image generated from the image, or the like.

As described above, the information processing device 1 according to the present exemplary example embodiment adopts a configuration including the creation location specifying unit 101 for specifying a location created by partial work that is a part of a series of work, in a product created by the series of work, and the labeling unit 102 for determining a label to be given to the partial work, using the language model M, caused to machine learn a natural language,, based on the place specified by the creation location specifying unit 101.

According to the above configuration, the creation location created by the partial work in the product created by the series of works is specified, and the label to be given to the partial work is determined based on the specified creation location. Since the actual state of the partial work is reflected in the creation location created by the partial work in the product, the label according to the actual state of the partial work can be determined by determining the label based on the creation location. Then, a series of works can be analyzed according to the actual state of the work by using the label given to the partial work. For example, it is also possible to find a partial work that is truly a bottleneck in the series of works by dividing the series of works into a plurality of partial works and giving a label to each partial work.

As described above, according to the information processing device 1, an effect is obtained that a series of works for creating a product can be analyzed according to the actual state of the work. In addition, since the content of a series of works is visualized by the label determined by the information processing device 1, the work that is a bottleneck can be identified, and the entire series of works can be optimized.

### (Labeling Program)

The functions of the information processing device 1 described above can also be achieved by a program. A labeling program according to the present exemplary example embodiment causes a computer to function as a creation location specifying means for specifying a location created by a partial work that is a part of a series of works in a product created by the series of works, and a labeling means for determining a label to be given to the partial work by using a language model M, caused to machine learn a natural language, based on the location specified by the creation location specifying means. According to this labeling program, an effect is obtained that a series of works can be analyzed according to the actual state of the work.

### (Flow of Labeling Method)

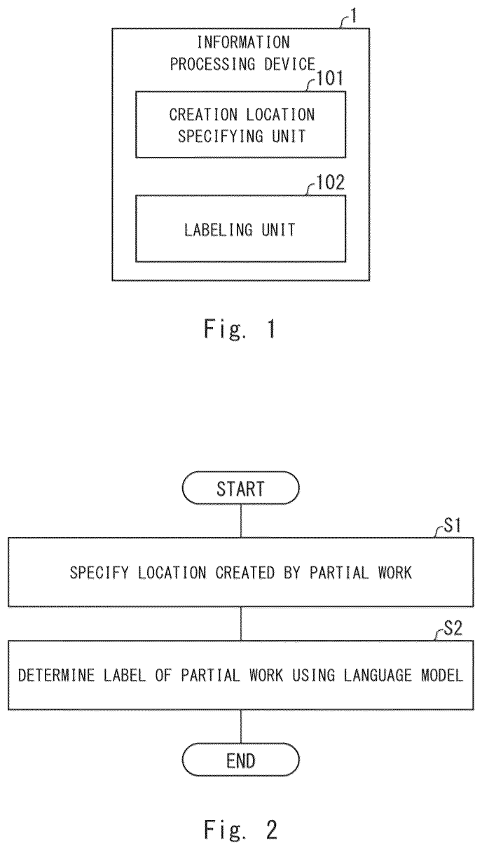

A flow of a labeling method according to the present exemplary example embodiment will be described with reference to FIG. 2. FIG. 2 is a flowchart illustrating the flow of the labeling method. An executing entity of each step in this labeling method may be a processor included in the information processing device 1, may be a processor included in another device, or an executing entity of each step may be a processor provided in each of different devices.

In S1 (creation location specifying processing), at least one processor specifies a location created by a partial work that is a part of a series of works in a product created by the series of works.

In S2 (labeling processing), at least one processor determines a label to be given to a partial work by using a language model M, caused to machine learn a natural language, based on the location specified in S1.

As described above, in the labeling method according to the present exemplary example embodiment, a configuration is adopted in which at least one processor executes creation location specifying processing of specifying a location created by a partial work that is a part of a series of works in a product created by the series of works, and labeling processing of determining a label to be given to the partial work by using the language model M, caused to machine learn a natural language, based on the location specified by the creation location specifying processing. According to this labeling method, an effect is obtained that a series of works for creating a product can be analyzed according to an actual state of the work.

### Second Exemplary Example Embodiment

A second exemplary example embodiment that is an example of the example embodiments of the present disclosure will be described in detail with reference to the drawings. Constituent elements having the same functions as the constituent elements described in the above-described exemplary example embodiment are denoted by the same reference signs, and the description thereof will be appropriately omitted. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Furthermore, each technique illustrated in the drawings referred to for describing the present exemplary example embodiment may also be adopted in another exemplary example embodiment included in the present disclosure within a scope in which no particular technical problem arises.

### (Configuration of Information Processing Device 1A)

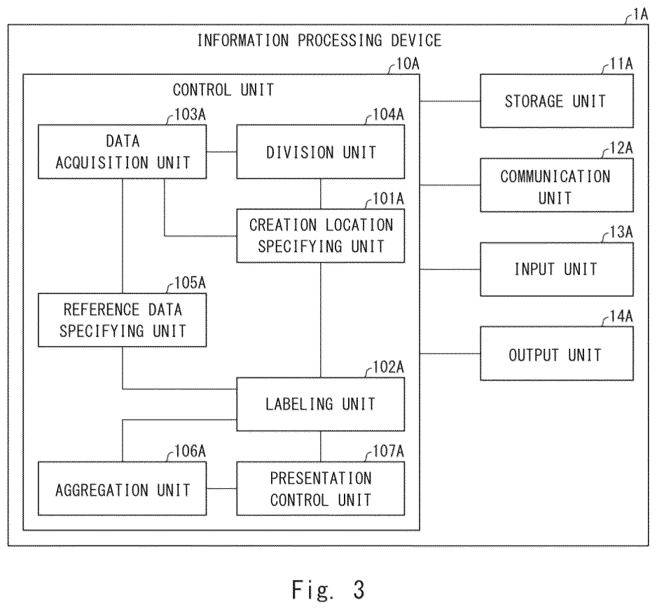

A configuration of an information processing device 1A according to the present exemplary example embodiment will be described with reference to FIG. 3. FIG. 3 is a block diagram illustrating a configuration of the information processing device 1A. The information processing device 1A is a device having a function of supporting work analysis. The information processing device 1A may be a local device used by individual users, or may be a server that provides work analysis support services to a plurality of users.

As illustrated, the information processing device 1A includes a control unit 10A for integrally controlling each unit of the information processing device 1A, and a storage unit 11A for storing various types of data to be used by the information processing device 1A. The information processing device 1A includes a communication unit 12A for the information processing device 1A to communicate with another device, an input unit 13A for accepting an input to the information processing device 1A, and an output unit 14A for the information processing device 1A to output data. The control unit 10A includes a creation location specifying unit 101A, a labeling unit 102A, a data acquisition unit 103A, a division unit 104A, a reference data specifying unit 105A, an aggregation unit 106A, and a presentation control unit 107A.

The creation location specifying unit 101A specifies a creation location that is a location created by a partial work that is a part of a series of works in a product created by the series of works, similarly to the creation location specifying unit 101 of the first exemplary example embodiment.

Similarly to the labeling unit 102 of the first exemplary example embodiment, the labeling unit 102A determines a label to be given to the partial work by using the language model M, caused to machine learn a natural language, based on the creation location specified by the creation location specifying unit 101A. Details of labeling by the labeling unit 102A will be described later.

The data acquisition unit 103A acquires various types of data necessary for providing an analysis support service. For example, the data acquisition unit 103A acquires a product created by a series of works to be analyzed. Furthermore, for example, the data acquisition unit 103A acquires a history of operations performed to create a product in a period in which the series of works is performed, and history information indicating a transition of the product in the period in which the series of works is performed. The data acquisition unit 103A may acquire data indicating a history of operations and data indicating a transition of a product as independent history information. The history of operations and the transition of a product can be acquired from a computer or the like on which a series of works is performed. Furthermore, for example, in a case where a product is created using a file management system such as Git, the information indicating the transition of the product can also be acquired from the file management system.

The division unit 104A divides a series of works performed to create a predetermined product into a plurality of partial works. Details of the processing by the division unit 104A will be described later.

The reference data specifying unit 105A specifies reference data that is data referred to by the creator of the product at the time of creating the product. It is not essential to provide the reference data specifying unit 105A. However, by providing the reference data specifying unit 105A, it becomes possible to consider the reference data in the determination of the label by the labeling unit 102A, and thus, it becomes possible to improve the accuracy of the label to be given.

The aggregation unit 106A aggregates the work time in each of the plurality of partial works for each partial work having the same label determined by the labeling unit 102A. It is not essential to provide the aggregation unit 106A. However, by providing the aggregation unit 106A, an effect is obtained that analysis on the work time for each partial work can be easily performed in addition to the effect obtained by the information processing device 1.

The presentation control unit 107A presents various types of information regarding the provision of the analysis support service. For example, the presentation control unit 107A may present the label determined by the labeling unit 102A, the aggregation result of the aggregation unit 106A, or the like. A presentation mode of the information by the presentation control unit 107A is arbitrary. For example, the presentation control unit 107A may cause the output unit 14A to output the above-described label or the like, or may cause a display device (e.g., a terminal device used by a user) external to the information processing device 1A to output the label or the like via the communication unit 12A. Furthermore, an output mode is also arbitrary, and for example, the presentation control unit 107A may cause a label or the like to be displayed and output, may cause a voice to be output, or may cause a print to be output. The label determined by the labeling unit 102A, the aggregation result of the aggregation unit 106A, or the like does not necessarily need to be presented to the user. For example, these pieces of information may be supplied for analysis of work without being presented to the user.

### (Outline of Processing)

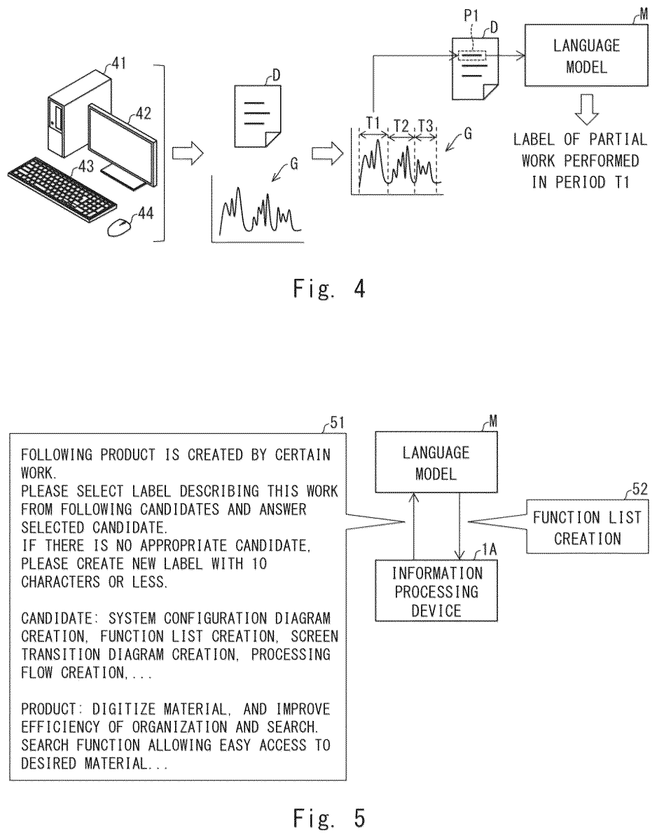

An outline of processing executed by the information processing device 1A will be described with reference to FIG. 4. FIG. 4 is a diagram illustrating an outline of processing executed by the information processing device 1A. In the example of FIG. 4, a document D in a text format is created as a product by a series of works using a computer 41, a display device 42, a keyboard 43, and a mouse 44. In addition, FIG. 4 illustrates, as a graph G, a time-series change in degree of activity of an input operation using the keyboard 43 and the mouse 44 in this series of works. A method of calculating the degree of activity will be described later.

In the example of FIG. 4, the division unit 104A divides a series of works performed to create the document D based on the time-series change in the degree of activity illustrated in the graph G. Specifically, the division unit 104A divides the series of works into three, a partial work performed in period T1, a partial work performed in period T2, and a partial work performed in period T3.

Next, the creation location specifying unit 101A specifies a location created by each partial work in the document D. For example, in the example of FIG. 4, the creation location specifying unit 101A specifies a description location P1 that is a part of the document D as the creation location created by the partial work performed in period T1. Although not illustrated, the creation location specifying unit 101A also specifies each creation location created by each partial work performed in periods T2 and T3.

Next, the labeling unit 102A determines a label to be given to the partial work performed in period T1 using the language model M, caused to machine learn a natural language, based on the description location P1 specified by the creation location specifying unit 101A. Specifically, the labeling unit 102A inputs the description location P1 to the language model M, causes the language model to infer about the label to be given to the partial work performed in period T1, and determines the label to be given to the partial work performed in period T1 based on the inference result. Although not illustrated, the labeling unit 102A similarly labels each partial work performed in periods T2 and T3.

As described above, according to the information processing device 1A, a series of works for creating the document D can be divided in accordance with the actual state of the work illustrated in the graph G, and each partial work obtained by the division can be labeled. As a result, a series of works for creating the document D using the label can be analyzed according to the actual state of the work, the efficiency of each partial work can be improved, and hence the entire series of works can be optimized.

### (Division of Work)

As described above, the division unit 104A divides a series of works performed to create a predetermined product into a plurality of partial works. Details of the processing executed by the division unit 104A will be described below. The division unit 104A merely needs to be able to divide a series of works into unified blocks, and the division method is not limited to the following example.

For example, as in the example of FIG. 4, the division unit 104A may divide the series of works into a plurality of partial works based on the time-series change in the degree of activity of the input operation to the computer 41 used to create the product in the period in which the series of works is performed. As a result, in addition to the effects obtained by the information processing device 1, an effect is obtained that the partial work according to the actual state of the work can be automatically defined without being bound by the existing work classification.

Here, the degree of activity of the input operation is an index indicating how actively the input operation is being performed. For example, in a case where an input operation is performed using two input devices of the keyboard 43 and the mouse 44 as in the example of FIG. 4, the division unit 104A may calculate the degree of activity from the history of input operations accepted by these input devices. Specifically, for example, the division unit 104A may calculate the number of times of touching the keys of the keyboard 43 as the degree of activity of the keyboard operation, calculate the movement amount of the mouse 44 as the degree of activity of the mouse operation, and calculate the overall degree of activity by integrating these degrees of activities. For example, the division unit 104A may calculate a movement amount (also referred to as a movement distance) of a cursor (i.e., a display object operated by the mouse) displayed on the display device 42 as the movement amount of the mouse 44. Furthermore, the division unit 104A may reflect the number of times of operations such as clicking on the mouse 44 on the degree of activity.

The division unit 104A may calculate the degree of activity only from the history of keyboard operations, or may calculate the degree of activity only from the history of mouse operations. Furthermore, the division unit 104A may calculate the degree of activity from the history of input operations using any input device other than the keyboard and the mouse. For example, the division unit 104A may calculate the degree of activity from a history of input operations by at least any of the touch panel, the stylus pen, and the touch pad. Furthermore, in a case where voice input is performed in creating a product, the division unit 104A may calculate the degree of activity from the total duration of the input voice, the number of characters of the text generated by performing voice recognition on the voice, and the like.

In addition, various methods can be applied as a method of dividing based on the time-series change in the degree of activity. For example, the division unit 104A may detect a period in which a state in which the degree of activity is equal to or less than a predetermined threshold value is continued for a predetermined time or longer in a period in which a series of works is performed. Then, the division unit 104A may break the series of works into a plurality of partial works by dividing the series of works in each detected period. In the example of FIG. 4, the series of works in creating the document D by such a method is divided into three partial works.

Furthermore, for example, the division unit 104A may detect a predetermined operation performed for each work break from a history of input operations to the computer 41 used to create a product in a period in which the series of works is performed. Then, the division unit 104A may break the series of works into a plurality of partial works by dividing the series of works at each time at which the predetermined operation is detected. Even in a case where such a configuration is adopted, an effect is obtained that the partial work according to the actual state of the work can be automatically defined without being bound by the existing work classification, in addition to the effect of the information processing device 1.

What kind of operation to set the predetermined operation as may be defined in advance. For example, in a case where the product is electronic data, the division unit 104A may detect an operation of saving the electronic data, an operation of displaying a preview of the electronic data, or the like as the predetermined operation. Furthermore, for example, in a case where a work for creating new electronic data from the original data is performed, a work of checking the original data and the new electronic data by collating the original data and the new electronic data may be performed for each work break. Therefore, the division unit 104A may detect an operation of displaying the original data together with the created electronic data as the predetermined operation.

Furthermore, the division unit 104A may divide the series of works into a plurality of partial works based on the behavior of the creator of the product. For example, the division unit 104A may perform the above division based on an analysis result of an image obtained by photographing the creator who is working. In this case, the division unit 104A may divide the series of works at the time at which a predetermined action performed for each work break is detected. Examples of the predetermined action include, for example, standing up from a seat, stretching, eating and drinking, and operating a device not used for work such as a smartphone.

Furthermore, the division unit 104A may perform the above division based on operation states of various devices used or worn by the worker. For example, it is assumed that the worker is wearing a wearable device capable of measuring vital data such as a smart watch. In this case, the division unit 104A may specify the time at which the worker changes from the tense state to the relaxed state from, for example, the time-series change in the vital data such as the heart rate, and break the series of works at the time.

### (Details of Labeling)

Details of labeling by the labeling unit 102A will be described with reference to FIG. 5. FIG. 5 is a diagram illustrating an example of labeling. In the example of FIG. 5, the information processing device 1A (more specifically, the labeling unit 102A) inputs a prompt 51 to the language model M, and an answer 52 to the prompt 51 is output from the language model M. The language model M may be provided external to the information processing device 1A (e.g., a server) as in the example of FIG. 5, or the language model M may be stored in the information processing device 1A.

The prompt 51 is a prompt for instructing to infer about a label to be given to the partial work. Specifically, the prompt 51 is a prompt that includes a “product” and a “candidate”, and instructs to select a label describing a work for creating the “product” from the “candidate” and answer. Here, the “product” in the prompt 51 is not the entire product created by the series of works, and is a location of the product specified by the creation location specifying unit 101A, that is, a creation location created by the partial work.

A portion other than the content of the “product” in the prompt 51 is a fixed form, and can be formed into a template. By storing the template in the storage unit 11A, and the like, the labeling unit 102A may input a description of the creation location specified by the creation location specifying unit 101A to the portion of the “product” in the template to generate the prompt 51.

In addition, the prompt 51 includes a sentence instructing to create a new label if there is no appropriate candidate. By using the prompt including such a sentence, it is possible to perform labeling without being bound by candidates while preventing a label unsuitable for analysis from being given or labels from being excessively diversified. In addition, in a sentence instructing to create a new label included in the prompt 51, it is designated to set the label to be created to be equal to or less than 10 characters. As described above, the sentence instructing to create a new label may include a condition for the label to be created by the language model M. As a result, it is possible to cause the language model M to create a label that satisfies a desired condition.

In the prompt 51 in FIG. 5, specifically, a sentence “digitize material, . . . ” is input to a portion of “product”. Furthermore, in the prompt 51, typical works performed at the time of designing a computer program such as system configuration diagram creation and function list creation are listed as “candidate”. Then, in the example of FIG. 5, the language model M outputs, with respect to the input prompt 51, an answer 52 indicating that the “function list creation”, that is one of the “candidates” described above, is the label to be given to the partial work. Based on the answer 52, the labeling unit 102A can determine the label to be given to the partial work for creating the “product” starting with “digitizing material” as “function list creation”.

It is not essential to include a sentence instructing to generate a new label in the prompt to be input to the language model M. In this case, the language model M outputs that which is the most appropriate as a label among the candidates. In addition, the language model M may be caused to output the suitability as a label to be given to a partial work of each candidate. In this case, the labeling unit 102A may determine a label having the highest suitability as a label to be given to the partial work. Furthermore, for example, the labeling unit 102A may cause the presentation control unit 107A to present each candidate and the suitability thereof, and may cause the user to select which candidate to adopt. In this case, the labeling unit 102A determines the candidate selected by the user as a label to be given to the partial work.

It is not essential to include candidates for a label in the prompt to be input to the language model M. In a case where the candidates for a label are not included in the prompt to be input to the language model M, the labeling unit 102A may generate a prompt for instructing to infer what kind of label should be given to the partial work. Alternatively, the labeling unit 102A may generate a prompt for instructing to generate a label to be given to a partial work.

As described above, the labeling unit 102A may input a prompt including the creation location specified by the creation location specifying unit 101A to the language model M, cause the language model to infer about the label to be given to a partial work, and determine a label to be given to the partial work based on a result of the inference. As a result, in addition to the effect obtained by the information processing device 1, an effect is obtained that an appropriate label can be determined in direct consideration of the creation location specified by the creation location specifying unit 101A.

As described above, the labeling unit 102A may input a prompt including candidates for a label in addition to the creation location specified by the creation location specifying unit 101A to the language model M, cause the language model M to infer which candidate is appropriate as the label of the partial work, and determine the label to be given to the partial work based on the result of the inference. As a result, in addition to the effect obtained by the information processing device 1, an effect is obtained that the partial work can be labeled within the range of the candidates.

Furthermore, as described above, the prompt to input to the language model M may be a prompt for instructing to generate a new label in a case where there is no appropriate label as a label of a partial work among the candidates for a label. As a result, in addition to the effects obtained by the information processing device 1, an effect is obtained that labeling can be performed without being bound by candidates while preventing a label unsuitable for analysis from being given or labels from being excessively diversified.

Furthermore, the labeling unit 102A may include various types of information serving as a reference for inferring a label to be given to the partial work in the prompt to be input to the language model M. This makes it possible to increase the possibility that an appropriate label will be determined.

For example, as described above, the information processing device 1A may include the reference data specifying unit 105A. The reference data specifying unit 105A specifies reference data that is data referred to by the creator of the product at the time of creating the product. For example, the reference data specifying unit 105A can specify the reference data from a history of input operations to the computer used to create the product in a period in which a series of works for creating the product are performed. Specifically, the reference data specifying unit 105A may detect an operation of opening (in other words, displaying or reproducing) data different from the product or an operation of displaying data different from the product on a screen on which the product has been displayed. Then, the reference data specifying unit 105A may specify the data opened, the data displayed, or the data reproduced by the operation as the reference data.

In a case where the reference data specifying unit 105A specifies the reference data, the labeling unit 102A generates a prompt including the reference data specified by the reference data specifying unit 105A in addition to the creation location specified by the creation location specifying unit 101A. This prompt may instruct to estimate the label in consideration of the content of the reference data. Furthermore, this prompt may include a sentence indicating that the reference data is data referred to during execution of the partial work to be labeled.

Then, the labeling unit 102A inputs the generated prompt to the language model M, causes the language model to infer about the label to be given to the partial work in consideration of the reference data, and determines the label to be given to the partial work based on the result of the inference. Thus, in addition to the effect obtained by the information processing device 1, an effect is obtained that the possibility an appropriate label will be determined can be increased.

For example, it is assumed that the product is a medical document, and an operation of opening (in other words, displaying) an electronic medical record of a certain patient is performed in a period in which one partial work of a series of works for creating the medical document is performed. In this case, the reference data specifying unit 105A detects the operation from the history of input operations, and specifies the electronic medical record opened by the operation as the reference data. Then, the labeling unit 102A generates a prompt including the electronic medical record specified by the reference data specifying unit 105A in addition to the creation location specified by the creation location specifying unit 101A, and inputs the prompt to the language model M. As a result, since the description content of the electronic medical record is considered in the inference regarding the label to be given to the partial work, the possibility that an appropriate label will be determined can be increased.

### (Example of Result Display)

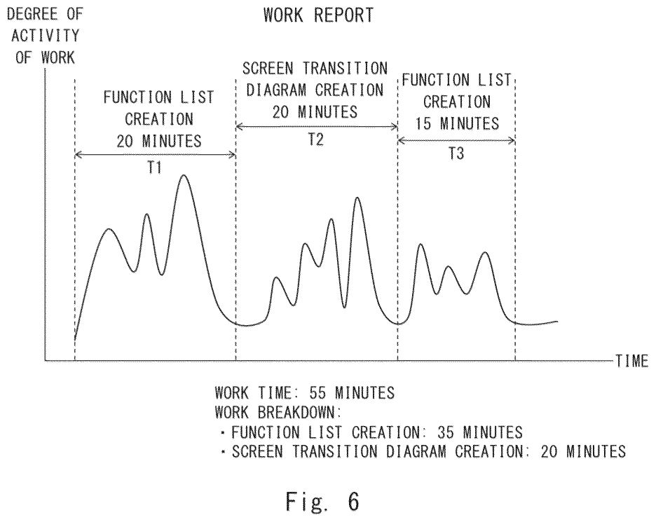

The presentation control unit 107A may present the label determined by the labeling unit 102A to the user. Furthermore, the presentation control unit 107A may present the aggregation result of the aggregation unit 106A. The presentation of the label and the like by the presentation control unit 107A will be described with reference to FIG. 6. FIG. 6 is a diagram illustrating an example of a display screen displayed by the presentation control unit 107A. More specifically, the display screen illustrated in FIG. 6 shows an example of a display screen for presenting the label determined by the labeling unit 102A together with the aggregation result of the aggregation unit 106A.

In the display screen example of FIG. 6, a graph indicating the time-series change in the degree of activity of the work in the series of works is displayed as the work report of the series of works for generating the product. Such a graph can be generated using the time-series degree of activity calculated by the division unit 104A. In addition, this graph is divided into three periods T1 to T3. These divisions indicate division results by the division unit 104A. That is, the work in each of the periods T1 to T3 is a partial work.

In addition, in the display screen example of FIG. 6, a label such as “function list creation” is displayed in each period of T1 to T3 (in other words, each partial work) together with the duration of each period (in other words, the time in which the partial work is performed). These labels are determined by the labeling unit 102A.

Furthermore, in the display screen example of FIG. 6, the total time of the series of works is displayed as “work time”, and the aggregation result obtained by aggregating the work time in each of the partial works in each period of T1 to T3 for each partial work having the same label is displayed as “work breakdown”. Specifically, the same label “function list creation” is given to both the partial work performed in period T1 and the partial work performed in period T3. Therefore, in the display screen example of FIG. 6, it is indicated that the work time of the “function list creation” was 35 minutes as the aggregation result of the work times (20 minutes, 15 minutes) of each of the partial works. For the partial work in period T2 to which the label “screen transition diagram creation” is given, there is no other partial work to which the same label is given, and thus 20 minutes that is the work time in period T2 is displayed as it is as the aggregation result. Such aggregation is performed by the aggregation unit 106A as described above.

### (Flow of Processing)

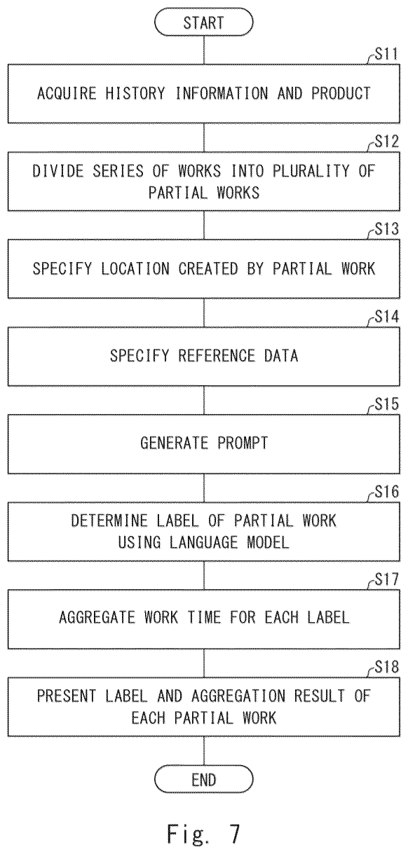

A flow of processing executed by the information processing device 1A will be described with reference to FIG. 7. FIG. 7 is a flowchart illustrating a flow of processing executed by the information processing device 1A. The flowchart of FIG. 7 includes each processing of the labeling method according to the present exemplary example embodiment. FIG. 7 illustrates processing performed after a series of works for creating a product is ended, and the history of operations performed to create the product in the period in which the series of works for creating the product is performed and the history information indicating the transition of the product in the period in which the series of works is performed are recorded.

In S11, the data acquisition unit 103A acquires the history information recorded as described above and the product created by the series of works. A method of acquiring the history information and the product is arbitrary. For example, the data acquisition unit 103A may acquire history information and a product from another device (e.g., the computer 41 illustrated in FIG. 4) via the communication unit 12A, or may acquire history information and a product input via the input unit 13A. The history information and the product do not necessarily need to be acquired at the same time. Furthermore, the history information and the product may be acquired by different acquisition methods.

In S12, the division unit 104A divides the series of works performed to create the product acquired in S11 into a plurality of partial works by using the history of operations in the period in which the series of works is performed indicated in the history information acquired in S11. For example, the division unit 104A may calculate the degree of activity of the input operation at each time of the period in which the series of works is performed from the history, and detect a period in which a state in which the calculated degree of activity is equal to or less than a predetermined threshold value is continued for a predetermined time or longer. Then, the division unit 104A may break the series of works into a plurality of partial works by dividing the series of works in each detected period. Furthermore, for example, the division unit 104A may detect a predetermined operation performed for each work break from the history and break the series of works at each time at which the predetermined operation is detected to divide a series of works into a plurality of partial works.

In S13 (creation location specifying processing), the creation location specifying unit 101A specifies a location created by a partial work that is a part of a series of works in a product created by the series of works. Specifically, the creation location specifying unit 101A performs, for each of the plurality of partial works divided in S12, processing of specifying which location in the product acquired in S11 has been created by one partial work divided in S12. For example, the creation location specifying unit 101A may specify the start time and the end time of each partial work based on the division result of S12. Then, the creation location specifying unit 101A specifies a location created in the period from the start time to the end time of one partial work, that is, the creation location described above, in the product acquired in S11 based on the transition of the product in the period in which the series of works is performed, indicated in the history information acquired in S11. For example, the creation location specifying unit 101A may specify a difference between the product at the time point of the end time of one partial work and the product at the time point of the start time of the partial work as the creation location. This processing is performed for each partial work.

In S14, the reference data specifying unit 105A specifies the reference data in each partial work defined by the processing of S12 by using the history of operations in the period in which the series of works is performed indicated in the history information acquired in S11. Data is not necessarily referred to in each partial work. Therefore, in S14, a partial work in which the reference data specifying unit 105A cannot specify the reference data may occur.

In S15, the labeling unit 102A generates a prompt for instructing to infer about a label to be given to the work that created the creation location, that is, the partial work, including the creation location specified in S13. The labeling unit 102A may generate a prompt for each of a plurality of partial works, or may collectively generate one prompt for a plurality of partial works. In the latter case, the labeling unit 102A may generate a prompt for instructing to infer about a label to be given to each partial work that created each creation location, including each creation place by a plurality of partial works.

In S16 (labeling processing), the labeling unit 102A determines a label to be given to the partial work by using the language model M, caused to machine learn a natural language, based on the creation location specified in the processing of S13. Specifically, the labeling unit 102A inputs a prompt (generated in S15) including the creation location specified in the processing of S13 to the language model M, and determines a label to be given to the partial work based on the output from the language model M. The label is determined for each partial work defined by the processing of S12.

In S17, the aggregation unit 106A aggregates the work time in each of the plurality of partial works defined by the processing of S12 for each partial work having the same label determined in S16.

In S18, the presentation control unit 107A presents the label of each partial work determined in S16 together with the aggregation result in S17. For example, the presentation control unit 107A may display a display screen as illustrated in FIG. 6. Accordingly, the processing of FIG. 7 ends.

[Modified Example] An executing entity of each processing described in the above-described exemplary example embodiment is arbitrary, and is not limited to the above-described example. For example, a system having functions similar to those of the information processing devices 1 and 1A can be constructed by a plurality of devices capable of communicating with each other. The executing entity of each processing illustrated in the flowchart of FIG. 7 may be one device (may be rephrased as a processor) or a plurality of devices (may be similarly rephrased as processors).

### Example of Implementation by Software

Some or all of the functions of the information processing devices 1 and 1A (hereinafter also referred to as “each of the above devices”) may be implemented by hardware such as an integrated circuit (IC chip), or may be implemented by software.

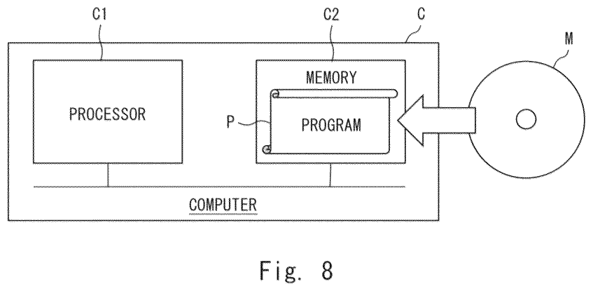

In the latter case, each of the above devices is implemented by, for example, a computer that executes instructions of a program, that is software for implementing each function. An example of such a computer (hereinafter, referred to as a computer C) is illustrated in FIG. 8. FIG. 8 is a block diagram illustrating a hardware configuration of the computer C functioning as each of the above devices.

The computer C includes at least one processor C1 and at least one memory C2. A program (labeling program) P for causing the computer C to operate as each of the above devices is recorded in the memory C2. In the computer C, the processor C1 reads the program P from the memory C2 and executes the program P to implement each function of each of the above devices.

Examples of the processor C1 include, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, and a combination thereof. Examples of the memory C2 include a flash memory, a Hard Disk Drive (HDD), a Solid State Drive (SSD), and a combination thereof.

The computer C may further include a Random Access Memory (RAM) for expanding the program P at the time of execution and temporarily storing various types of data. The computer C may further include a communication interface for transmitting and receiving data to and from another device. The computer C may further include an input/output interface for connecting input/output devices such as a keyboard, a mouse, a display, and a printer.

Furthermore, the program P can be recorded on a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above devices may be implemented by a single processor provided in a single computer, may be implemented in cooperation with a plurality of processors provided in a single computer, or may be implemented in cooperation with a plurality of processors provided in each of a plurality of computers. The program for causing each of the above devices to implement each of the above functions may be stored in a single memory provided in a single computer, may be stored in a distributed manner in a plurality of memories provided in a single computer, or may be stored in a distributed manner in a plurality of memories provided in each of a plurality of computers.

### Supplementary Information

The present disclosure includes the techniques described in the following Supplementary Notes. However, the present disclosure is not limited to the techniques described in the following supplementary notes, and various modifications can be made within the scope described in the claims.

### (Supplementary Note A1)

An information processing device including a creation location specifying means for specifying a location created by a partial work that is a part of a series of works in a product created by the series of works, and a labeling means for determining a label to be given to the partial work by using a language model, caused to machine learn a natural language, based on the location specified by the creation location specifying means.

### (Supplementary Note A2)

The information processing device according to supplementary note A1, further including a dividing means for dividing the series of work into a plurality of the partial works based on a time-series change in a degree of activity of an input operation to a computer used to create the product in a period in which the series of works is performed.

### (Supplementary Note A3)

The information processing device according to supplementary note A1, further including a dividing means for detecting a predetermined operation performed for each work break from a history of an input operation to a computer used to create the product in a period in which the series of works is performed, and dividing the series of works into a plurality of the partial works by breaking the series of works at each time at which the predetermined operation is detected.

### (Supplementary Note A4)

The information processing device according to any of supplementary notes A1 to A3, in which the labeling means inputs a prompt including the location specified by the creation location specifying means to the language model, causes the language model to infer about a label to be given to the partial work, and determines a label to be given to the partial work based on a result of the inference.

### (Supplementary Note A5)

The information processing device according to supplementary note A4, in which the labeling means inputs a prompt including candidates for a label in addition to the location specified by the creation location specifying means to the language model, causes the language model to infer which candidate is appropriate as the label of the partial work, and determines the label to be given to the partial work based on a result of the inference.

### (Supplementary Note A6)

The information processing device according to supplementary note A5, in which the prompt is a prompt for instructing to generate a new label in a case where there is no appropriate label as the label of the partial work among the candidates.

### (Supplementary Note A7)

The information processing device according to any of supplementary notes A4 to A6, further including a reference data specifying means for specifying reference data, that is data referred to in creating the product, from a history of input operations to a computer used to create the product in a period in which the series of works is performed, in which
the labeling means inputs a prompt including the reference data in addition to the location specified by the creation location specifying means into the language model, causes the language model to infer about a label to be given to the partial work in consideration of the reference data, and determines a label to be given to the partial work based on a result of the inference.

### (Supplementary Note A8)

The information processing device according to any of supplementary notes A1 to A7, further including an aggregation means for aggregating a work time in each of the plurality of partial works for each of the partial works having the same label determined by the labeling means.

### (Supplementary Note B1)

A labeling method in which at least one processor executes,
creation location specifying processing of specifying a location created by a partial work that is a part of a series of works in a product created by the series of works, and

labeling processing of determining a label to be given to the partial work by using a language model, caused to machine learn a natural language, based on the location specified in the creation location specifying processing.

### (Supplementary Note B2)

The labeling method according to supplementary note B1, further including division processing in which the at least one processor divides the series of work into a plurality of the partial works based on a time-series change in a degree of activity of an input operation to a computer used to create the product in a period in which the series of works is performed.

### (Supplementary Note B3)

The labeling method according to supplementary note B1, further including division processing in which the at least one processor detects a predetermined operation performed for each work break from a history of input operations to a computer used to create the product in a period in which the series of works is performed, and divides the series of works into a plurality of the partial works by breaking the series of works at each time at which the predetermined operation is detected.

### (Supplementary Note B4)

The labeling method according to any of supplementary notes B1 to B3, in which in the labeling processing, the at least one processor inputs a prompt including the location specified in the creation location specifying processing to the language model, causes the language model to infer about a label to be given to the partial work, and determines a label to be given to the partial work based on a result of the inference.

### (Supplementary Note B5)

The labeling method according to supplementary note B4, in which in the labeling processing, the at least one processor inputs a prompt including candidates for a label in addition to the location specified in the creation location specifying processing to the language model, causes the language model to infer which candidate is appropriate as the label of the partial work, and determines the label to be given to the partial work based on a result of the inference.

### (Supplementary Note B6)

The labeling method according to supplementary note B5, in which the prompt is a prompt for instructing to generate a new label in a case where there is no appropriate label as the label of the partial work among the candidates.

### (Supplementary Note B7)

The labeling method according to any of supplementary notes B4 to B6, further including
reference data specifying processing in which the at least one processor specifies reference data that is data referred to in creating the product from a history of input operations to a computer used to create the product in a period in which the series of works is performed, and
in the labeling processing, the at least one processor inputs a prompt including the reference data in addition to the location specified in the creation location specifying processing to the language model, causes the language model to infer about a label to be given to the partial work in consideration of the reference data, and determines a label to be given to the partial work based on a result of the inference.

### (Supplementary Note B8)

The labeling method according to any of supplementary notes B1 to B7, further including aggregation processing in which the at least one processor aggregates a work time in each of the plurality of partial works for each of the partial works having the same label determined by the labeling processing.

### (Supplementary Note C1)

A labeling program for causing a computer to function as a creation location specifying means for specifying a location created by a partial work that is a part of a series of works in a product created by the series of works, and a labeling means for determining a label to be given to the partial work by using a language model, caused to machine learn a natural language, based on the location specified by the creation location specifying means.

### (Supplementary Note C2)

The labeling program according to supplementary note C1, further causing the computer to function as a division means for dividing the series of work into a plurality of the partial works based on a time-series change in a degree of activity of an input operation to a computer used to create the product in a period in which the series of works is performed.

### (Supplementary Note C3)

The labeling program according to supplementary note C1, further causing the computer to function as a division means for detecting a predetermined operation performed for each work break from a history of input operations to a computer used to create the product in a period in which the series of works is performed, and dividing the series of works into a plurality of the partial works by breaking the series of works at each time at which the predetermined operation is detected.

### (Supplementary Note C4)

The labeling program according to any of supplementary notes C1 to C3, in which the labeling means inputs a prompt including the location specified by the creation location specifying means to the language model, causes the language model to infer about a label to be given to the partial work, and determines a label to be given to the partial work based on a result of the inference.

### (Supplementary Note C5)

The labeling program according to supplementary note C4, in which the labeling means inputs a prompt including candidates for a label in addition to the location specified by the creation location specifying means to the language model, causes the language model to infer which candidate is appropriate as the label of the partial work, and determines the label to be given to the partial work based on a result of the inference.

### (Supplementary Note C6)

The labeling program according to supplementary note C5, in which the prompt is a prompt for instructing to generate a new label in a case where there is no appropriate label for the partial work among the candidates.

### (Supplementary Note C7)

The labeling program according to any of supplementary notes C4 to C6, further causing the computer to function as a reference data specifying means for specifying reference data, that is data referred to in creating the product, from a history of input operations to a computer used to create the product in a period in which the series of works is performed, in which
the labeling means inputs a prompt including the reference data in addition to the location specified by the creation location specifying means into the language model, causes the language model to infer about a label to be given to the partial work in consideration of the reference data, and determines a label to be given to the partial work based on a result of the inference.

### (Supplementary Note C8)

The labeling program according to any of supplementary notes C1 to C7, further causing the computer to function as an aggregation means for aggregating a work time in each of the plurality of partial works for each of the partial works having the same label determined by the labeling means.

### (Supplementary Note D1)

An information processing device including at least one processor, in which the at least one processor executes,
creation location specifying processing of specifying a location created by a partial work that is a part of a series of works in a product created by the series of works, and
labeling processing of determining a label to be given to the partial work by using a language model, caused to machine learn a natural language, based on the location specified in the creation location specifying processing.

The information processing device may further include a memory. The memory may store a program for causing the at least one processor to execute each of the processing.

### (Supplementary Note D2)

The information processing device according to supplementary note D1, in which the at least one processor executes division processing of dividing the series of work into a plurality of the partial works based on a time-series change in a degree of activity of an input operation to a computer used to create the product in a period in which the series of works is performed.

### (Supplementary Note D3)

The information processing device according to supplementary note D1, in which the at least one processor further executes division processing of detecting a predetermined operation performed for each work break from a history of input operations to a computer used to create the product in a period in which the series of works is performed, and dividing the series of works into a plurality of the partial works by breaking the series of works at each time at which the predetermined operation is detected.

### (Supplementary Note D4)

The information processing device according to any of supplementary notes D1 to D3, in which in the labeling processing, the at least one processor inputs a prompt including the location specified in the creation location specifying processing to the language model, causes the language model to infer about a label to be given to the partial work, and determines a label to be given to the partial work based on a result of the inference.

### (Supplementary Note D5)

The information processing device according to supplementary note D4, in which in the labeling processing, the at least one processor inputs a prompt including candidates for a label in addition to the location specified in the creation location specifying processing to the language model, causes the language model to infer which candidate is appropriate as the label of the partial work, and determines the label to be given to the partial work based on a result of the inference.

### (Supplementary Note D6)

The information processing device according to supplementary note D5, in which the prompt is a prompt for instructing to generate a new label in a case where there is no appropriate label as the label of the partial work among the candidates.

### (Supplementary Note D7)

The information processing device according to any of supplementary notes D4 to D6, in which
the at least one processor executes reference data specifying processing of specifying reference data that is data referred to in creating the product from a history of input operations to a computer used to create the product in a period in which the series of works is performed, and
in the labeling processing, the at least one processor inputs a prompt including the reference data in addition to the location specified in the creation location specifying processing to the language model, causes the language model to infer about a label to be given to the partial work in consideration of the reference data, and determines a label to be given to the partial work based on a result of the inference.

### (Supplementary Note D8)

The information processing device according to any of supplementary notes D1 to D7, in which the at least one processor executes aggregation processing of aggregating a work time in each of the plurality of partial works for each of the partial works having the same label determined by the labeling processing.

### (Supplementary Note E)

A non-transitory recording medium recorded with a labeling program for causing a computer to execute,
creation location specifying processing of specifying a location created by a partial work that is a part of a series of works in a product created by the series of works, and
labeling processing of determining a label to be given to the partial work by using a language model, caused to machine learn a natural language, based on the location specified in the creation location specifying processing.

What is claimed is:

1. An information processing device comprising:
at least one memory for storing instructions; and
at least one processor coupled to the memory and configured to execute the instructions to:
specify a location created by a partial work that is a part of a series of works in a product created by the series of works; and
determine a label to be given to the partial work by using a language model trained on a natural language, based on the specified location.

2. The information processing device according to claim 1, wherein
the at least one processor is further configured to execute the instructions to;
divide the series of tasks into a plurality of the partial works based on a time series change in a degree of activity of an input operation to a computer used to create the product in a period in which the series of works is performed.

3. The information processing device according to claim 1, wherein
the at least one processor is further configured to execute the instructions to;
detect a predetermined operation performed for each work break from a history of input operations to a computer used to create the product in a period in which the series of works is performed, and
divide the series of works is into a plurality of the partial works by breaking the series of works at each time at which the predetermined operation is detected.

4. The information processing device according to claim 1, wherein
the at least one processor is further configured to execute the instructions to:
input a prompt including the specified location to the language model,
cause the language model to infer about a label to be given to the partial work, and
determine a label to be given to the partial work based on a result of the inference.

5. The information processing device according to claim 4, wherein
the at least one processor is further configured to execute the instructions to:
input a prompt including candidates for a label in addition to the specified location to the language model,
cause the language model to infer which candidate is appropriate as the label of the partial work, and
determine the label to be given to the partial work based on a result of the inference.

6. The information processing device according to claim 5, wherein
the prompt is a prompt for instructing to generate a new label in a case where there is no appropriate label as the label of the partial work among the candidates.

7. The information processing device according to claim 4, wherein
the at least one processor is further configured to execute the instructions to:
specify reference data that is data referred to in creating the product from a history of input operations to a computer used to create the product in a period in which the series of works is performed, and
the at least one processor is further configured to execute the instructions to:
input a prompt including the reference data in addition to the specified location to the language model,
cause the language model to infer about a label to be given to the partial work in consideration of the reference data, and
determine a label to be given to the partial work based on a result of the inference.

8. The information processing device according to claim 1, wherein the at least one processor is further configured to execute the instructions to:
aggregate a work time in each of the plurality of partial works for each of the partial works having the same determined label.

9. A labeling method in which at least one processor executes,
creation location specifying processing of specifying a location created by a partial work that is a part of a series of works in a product created by the series of works; and
labeling processing of determining a label to be given to the partial work by using a language model, caused to machine learn a natural language, based on the location specified in the creation location specifying processing.

10. The labeling method according to claim 9, further including division processing in which the at least one processor divides the series of work into a plurality of the partial works based on a time-series change in a degree of activity of an input operation to a computer used to create the product in a period in which the series of works is performed.

11. The labeling method according to claim 9, further including division processing in which the at least one processor detects a predetermined operation performed for each work break from a history of input operations to a computer used to create the product in a period in which the series of works is performed, and divides the series of works into a plurality of the partial works by breaking the series of works at each time at which the predetermined operation is detected.

12. The labeling method according to claim 9, in which in the labeling processing, the at least one processor inputs a prompt including the location specified in the creation location specifying processing to the language model, causes the language model to infer about a label to be given to the partial work, and determines a label to be given to the partial work based on a result of the inference.

13. The labeling method according to claim 12, in which in the labeling processing, the at least one processor inputs a prompt including candidates for a label in addition to the location specified in the creation location specifying processing to the language model, causes the language model to infer which candidate is appropriate as the label of the partial work, and determines the label to be given to the partial work based on a result of the inference.

14. The labeling method according to claim 13, in which the prompt is a prompt for instructing to generate a new label in a case where there is no appropriate label as the label of the partial work among the candidates.

15. The labeling method according to claim 9, further including
reference data specifying processing in which the at least one processor specifies reference data that is data referred to in creating the product from a history of input operations to a computer used to create the product in a period in which the series of works is performed, and
in the labeling processing, the at least one processor inputs a prompt including the reference data in addition to the location specified in the creation location specifying processing to the language model, causes the language model to infer about a label to be given to the partial work in consideration of the reference data, and determines a label to be given to the partial work based on a result of the inference.

16. The labeling method according to claim 9, further including aggregation processing in which the at least one processor aggregates a work time in each of the plurality of partial works for each of the partial works having the same label determined by the labeling processing.

17. A non-transitory computer readable medium stored with a labeling program for causing a computer to,
specify a location created by a partial work that is a part of a series of works in a product created by the series of works, and
determine a label to be given to the partial work by using a language model, caused to machine learn a natural language, based on the specified location.

18. The non-transitory computer readable medium according to claim 17, further storing a program that causes the computer to function as a division means for dividing the series of work into a plurality of the partial works based on a time-series change in a degree of activity of an input operation to a computer used to create the product in a period in which the series of works is performed.

19. The non-transitory computer readable medium according to claim 17, further storing a program that causes the computer to function as a division means for detecting a predetermined operation performed for each work break from a history of input operations to a computer used to create the product in a period in which the series of works is performed, and dividing the series of works into a plurality of the partial works by breaking the series of works at each time at which the predetermined operation is detected.

20. The non-transitory computer readable medium according to claim 17, in which a labeling means inputs a prompt including the location specified by a creation location specifying means to the language model, causes the language model to infer about a label to be given to the partial work, and determines a label to be given to the partial work based on a result of the inference.
